(19) United States
(12) Patent Application Publication
(10) Pub. No.: US 2006/0243758 A1
(43) Pub. Date: Nov. 2, 2006

(54) Solenoid-operated fluid valve and assembly incorporating same

(76) Inventors: Randolph S. Parks, Hamilton, OH (US); Raymond A. Prokop, Ingleside, IL (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/415,849

(22) Filed: May 2, 2006

Related U.S. Application Data
(60) Provisional application No. 60/676,748, filed on May 2, 2005.

(51) Int. Cl. B67D 3/00

(52) U.S. Cl. 222/504

(57) ABSTRACT

A solenoid-operated valve and valve assembly. The valve may be made from a fluid tube that has a magnetizable plunger or armature movably positioned in the body. A coil of wire is directly wound to the fluid tube, thereby reducing the air gap between magnetic flux path and plunger to increase the magnetic force imparted to the plunger. Winding the coil to the valve body removes the need for a separate sleeve or bobbin, and additionally allows for tighter spacing and reduced air gap, thereby increasing magnetic flux by allowing more coil turns and closer coil spacing to the plunger. In one form, the valve is packaged into a narrow (for example, 15 millimeters wide) configuration for close valve-to-valve stackable centers, thereby allowing multiple valves to be placed side-by-side for adhesive or related fluid dispensing applications.

### CROSS REFERENCE

This application claims the benefit of the filing date of U.S. Provisional Application No. 60/676,748, filed May 2, 2005.

### BACKGROUND OF THE INVENTION

The present invention relates generally to a fluid valve, and more particularly to a compact solenoid-controlled valve for use in dispensing viscous fluids.

Adhesives and other high-viscosity fluids require high-speed valves for proper operation. Traditional pneumatic-actuated valves, which rely on a supply of compressed air to reciprocally move a plunger back and forth in a fluid chamber to selectively open and close the valve, are not sufficiently responsive to high speed opening and closing sequences required for modern adhesive-dispensing equipment.

More recently, solenoid-operated valves have been developed to overcome this limitation. Unfortunately, such solenoid valves, which rely on electric current passing through a wound coil to develop an electromagnetic field with which to move a magnetically-susceptible plunger, are larger than their pneumatic counterparts. This is disadvantageous in that adhesive dispensing valves are frequently arranged in a side-by-side (also called stacked) array, and any increase in size would be incompatible with the tight dispensing patterns required of a stacked configuration. Further, many machines where such valves are installed have tight space restrictions, making large solenoids impossible to install. Traditional solenoids are constructed from a coil wound onto a bobbin that is placed over a partially magnetic fluid tube. The thickness of the bobbin and the necessary clearances between the bobbin inner diameter and the fluid tube outer diameter decreases the magnetic coupling efficiency of the solenoid. Further, the additional inner space taken up by the bobbin and gap result in fewer amp-turns for a given size coil, given a fixed coil outer diameter. Therefore, the valves had less power than would have been possible without such gaps.

What is desired is a device and method that combines the small size of the pneumatic-based valve and dispenser with the high-speed operation of the solenoid-based valve and dispenser to enable the application of adhesive or related high-viscosity fluids onto a substrate. It is also desired that such valves can be arranged in a stacked array to minimize the distance between adjacent lines or beads of deposited material. It is desired that a valve of minimum size yields the maximum amount of power from the coil. A more efficient magnetic coupling reduces heat generation from current supplied to the coil. It is further desired that such valves can operate at higher frequency operation without an excessive generation of heat in the solenoid, thereby allowing more power to be available to a simple valve package.

### SUMMARY OF THE INVENTION

These needs are met by the present invention, where a solenoid-operated valve assembly for use with fluids generally and viscous fluids particularly is disclosed. According to a first aspect of the invention, a solenoid-operated valve is disclosed. The valve includes a valve body made up of a fluid tube that defines a fluid chamber with fluid inlet and fluid outlet, an electrically-conductive coil (also called a coil winding) wrapped directly around at least a portion of the fluid tube such that upon a current flow through the coil, the coil forms a magnetic field at least in or around the fluid tube. In the present context, the term “directly” means that there is no separate bobbin or related sleeve placed between the coil winding and the fluid tube. It does not imply electrical contact between the fluid tube and the coil, as it will be understood by those skilled in the art that it is desirable to avoid such electrical contact (and the concomitant shorting) between the two. In that regard, the inclusion of an insulative layer, such as tape or other coating disposed on the coil or the fluid tube, is not construed to be destructive of such direct wrapping of the coil to the fluid tube. Such direct placement reduces gaps that would typically be associated with a bobbin or similar insert. The valve also includes a frame that defines a flux path for the magnetic field. A plunger is disposed within the fluid chamber and moves in response to the magnetic field. A bias force cooperates with the plunger to selectively keep the fluid outlet closed. The bias force is configured to be overcome by operation of the magnetic field on the plunger such that the fluid outlet opens, thereby allowing fluid flow through the fluid chamber.

Optionally, at least the portion of the valve body that is wrapped in the coil is made from a substantially non-magnetizable material. An integrated switch can be included in the valve to provide local purging or testing of the valve. A stop cooperative with the plunger may further be included. In a particular form, the fluid tube and the stop can be threadably engaged to form an integral structure. In the present context, two components that are rigidly secured to one another are considered integral in a functional sense, and would accordingly qualify as integral here, even if not of one-piece construction. The stop may be made from a magnetizable material, while the fluid tube is made from a substantially non-magnetizable material. The stop may include adjustable features to allow changes in plunger travel distance. In another particular form, the fluid chamber is fluidly isolated from the coil. In another option, the bias force comes from a spring. In yet another option, the fluid chamber is fluidly isolated from the coil. In still another option, the widthwise dimension of the valve is small (for example, approximately 15 millimeters) to facilitate side-by-side stacking of numerous such valve assemblies in a compact space. The valve may further comprise an outer casing formed around the valve body. In such case, the widthwise dimension of the outer casing is approximately 15 millimeters. A filler material may be placed between the outer casing and the valve body. In the present context, the term “radial profile” is used to designate the radially outward dimension of a generally cylindrical component. It will be understood to extend to situations where the component has non-cylindrical attributes in that in the orientation of a generally elongate valve and valve body, radial dimensions can extend in generally widthwise directions. In yet another form, the inlet, outlet and fluid chamber define a substantially linear (i.e., straight) flowpath, such that fluid passing through need not experience any changes in direction while in the valve.

According to another aspect of the invention, an adhesive dispenser includes numerous solenoid-operated valves that can be placed in a side-by-side arrangement. An electric cable (or related conductor) is used to provide current to an electrically-conductive coil on each of the valves, while a fluid conduit is used to supply the fluid to the valves, and an outlet nozzle is coupled to the fluid outlet of each of the valves. Each of the valves includes a valve body, a plunger disposed within the fluid chamber and moveably responsive to the magnetic field, and a bias force cooperative with the plunger to selectively keep the fluid outlet closed. The bias force can be overcome by operation of the magnetic field on the plunger, thereby allowing fluid flow through the fluid chamber. A first of the outer surfaces defines a smaller radial outward (i.e., widthwise) dimension than the second outer surface. In this way, the valve body resembles a thin elongate cylinder axially disposed at the end of or between one or more thick, axially compact cylinder(s). As with the previous aspect, the electrically-conductive coil is wrapped around and in contact with the first of outer surfaces of the valve body such that intervening structure, such as a bobbin or related sleeve, is not disposed between them.

According to yet another aspect of the invention, a method of dispensing a fluid through a valve is disclosed. The method includes configuring a fluid tube to have a fluid inlet and a fluid outlet. In addition, the construction of the valve is such that it includes an outer surface and an inner surface. The inner surface defines a fluid chamber inside the valve body. As with the previous aspects, a coil is wound directly around at least a portion of the periphery of the outer surface. The method also includes moveably disposing a plunger within the fluid chamber such that it is biased in a closed position. In this way, when electric current is passed through the coil winding, the plunger overcomes the bias to move to an open position, thereby allowing fluid from the fluid supply to pass through the fluid outlet end of the valve body.

Optionally, the method further includes cooling the solenoid with the fluid. In one form, a substantially linear flowpath allows fluid delivered therethrough to reduce coil heat buildup, thereby increasing the duty cycle of the valve. In addition, a housing can be used to package the valve in a widthwise relatively thin profile (for example, no greater than fifteen millimeters wide). The method may further comprise placing a stop adjacent one of the fluid inlet and outlet to limit travel of the plunger in the fluid chamber. In another option, the coil winding can be isolated from the fluid. A switch may be included disposed on the valve such that upon engagement of the switch by an operator, the valve is purged of residual fluid. The method may further include placing the fluid tube within a frame such that upon formation of the magnetic flux, the magnetic flux is enhanced in the fluid tube by its proximity to the frame. In addition, a stroke between the plunger and the stop can be adjusted.

### BRIEF DESCRIPTION OF THE DRAWINGS

FIG. 1 shows an exploded view of a valve assembly according to an embodiment of the present invention;

FIG. 2A shows a perspective view of a two-piece fluid tube that makes up a portion of a valve body;

FIG. 2B shows the construction of a portion of a valve body made by winding coil and placing covering around the fluid tube of FIG. 2A;

FIG. 3A shows a side view of a solenoid-operated fluid valve assembly incorporating the two-piece valve body assembly of FIGS. 2A through 2G;

FIG. 3B shows a front elevation cutaway view of the solenoid-operated fluid valve assembly of FIG. 3A;

FIG. 3C shows an enlarged detail view of the portion of the solenoid-operated fluid valve assembly of FIG. 3B;

FIG. 4A shows a front elevation view of the solenoid-operated fluid valve assembly of FIG. 3A;

FIG. 4B shows a side cutaway view of the solenoid-operated fluid valve assembly of FIG. 3A;

FIG. 5 shows an exploded view of an alternate embodiment of the valve assembly, including its connection to an electric power supply and fluid supply, as well as stop subassembly;

FIG. 6 shows a side cutaway view of the valve assembly of FIG. 5; and

FIG. 7 shows an attachment of a valve body to a stop frame of the alternate embodiment of FIG. 5.

### DETAILED DESCRIPTION OF THE PREFERRED EMBODIMENTS

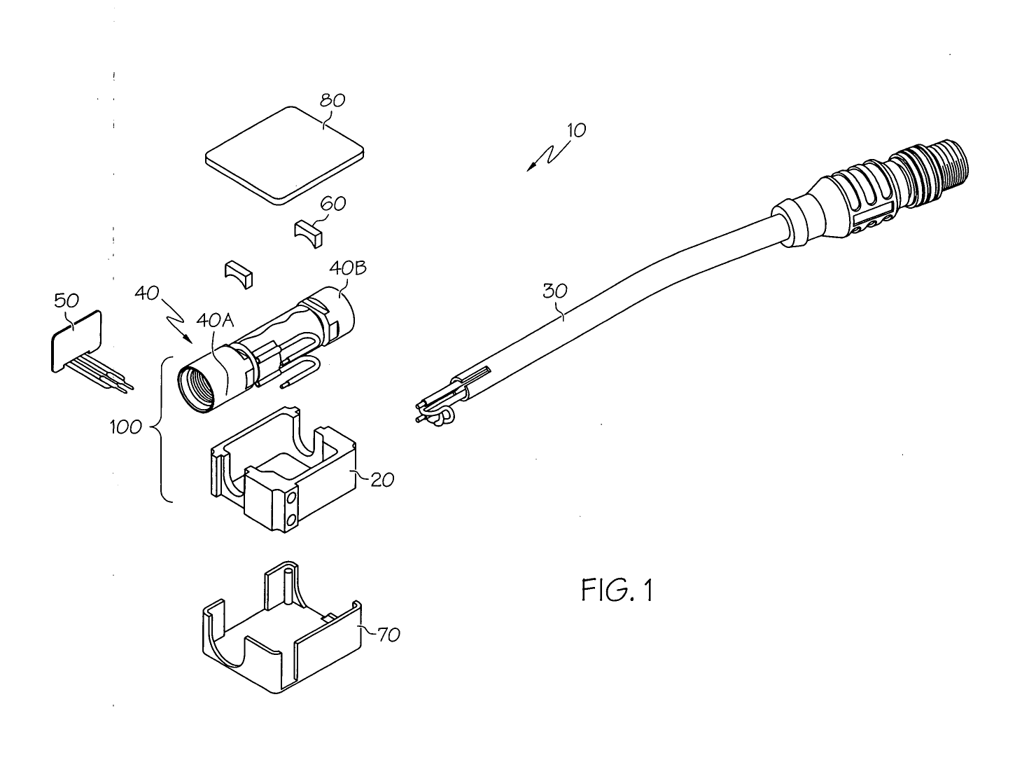

Referring first to FIG. 1, an exploded view of the solenoid-operated fluid valve assembly 10 is shown. Assembly 10 includes a coil frame 20 that fits within an outer casing 70. Coil frame 20 is shaped to accept a fluid tube 40 therein, and is made of a material that facilitates the conduction of a magnetic flux. In the present context, the term “assembly” is used to designate the construction of individual parts, and may be used interchangeably to refer to the assembled version of a valve (which is made from a valve body 100 made up of fluid tube 40, frame 20, coil 435 and valve internals, such as plunger 460 and biasing spring 455) as well as the entire solenoid-operated fluid valve assembly 10; the usage will be apparent from the context. An electric power supply (shown in the form of cable 30) is used to provide current flow through coils (discussed in more detail below) that are wound around and make up a part of a valve body 100 based on fluid tube 40. A switch 50 is placed within an opening in outer casing 70, and is electrically connected to cable 30, thereby acting as a local purge or reset switch situated on the forward-facing part of the assembly 10. In this way, it gives an operator local (rather than remote, such as at the end of a gluing machine) control over valve purging or related functions. Flux plugs 60 are used to provide coil and fluid tube 40 spacing for the assembly of valve assembly 10. Once the cable 30, fluid body 40, switch 50 and flux plugs 60 are fitted within coil frame 20, and coil frame 20 is in turn fitted within an optional outer casing 70, optional cover 80 can be placed over casing 70 to form a substantially enclosed assembly 10. In one form, the cover 80 and outer casing 70 may have complementary connectors (not shown) to allow for snap-fit or related resilient connection. Sealant (not shown) may be placed in the region where the wires from switch 50 extend, thereby protecting switch 50 from water, adhesive or other fluids. The coil frame 20 and outer casing 70 may additionally be filled with electrically non-conductive materials (not shown), such as a silica-based epoxy. Coil frame 20 (either alone or in conjunction with outer casing 70) may define a housing into which the remaining components discussed above can be placed or otherwise attached to.

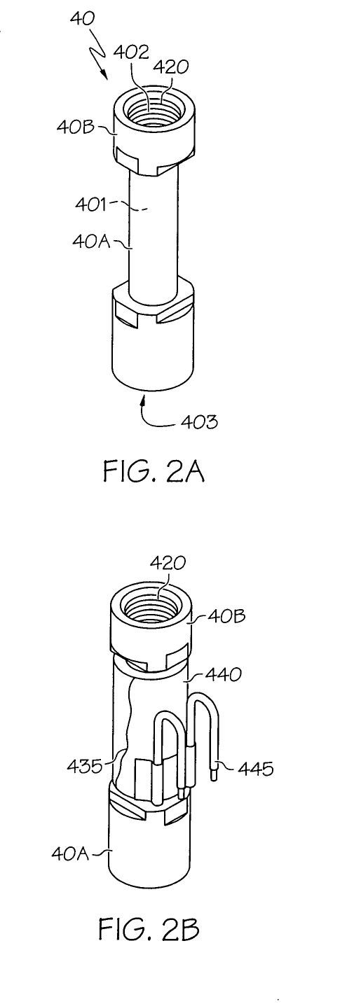

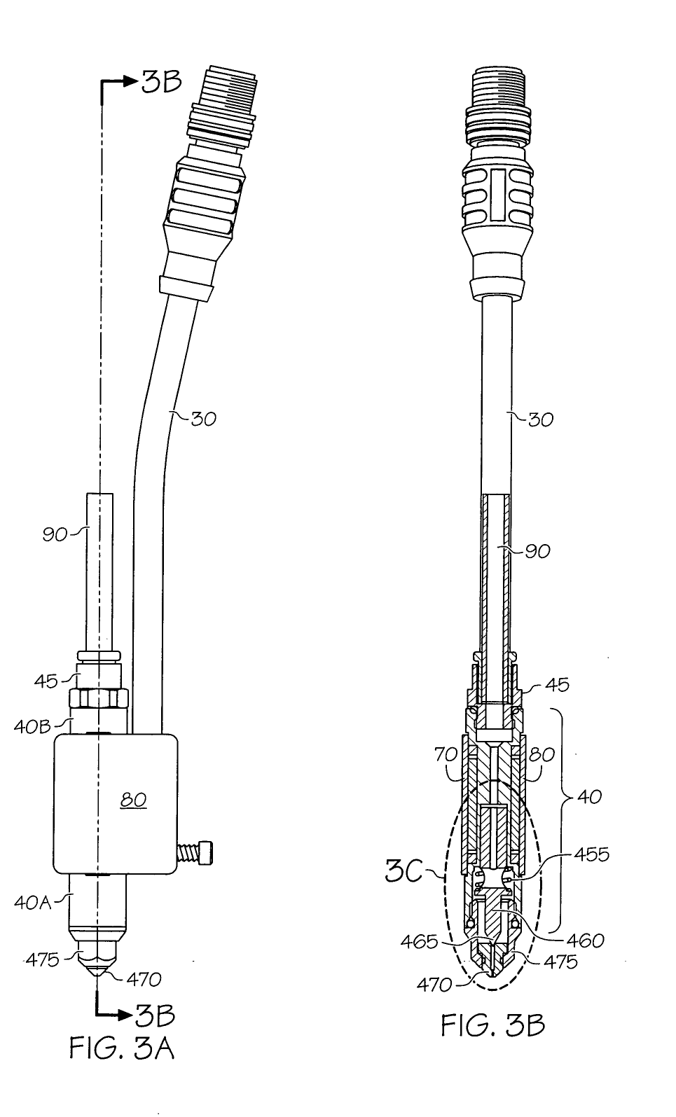

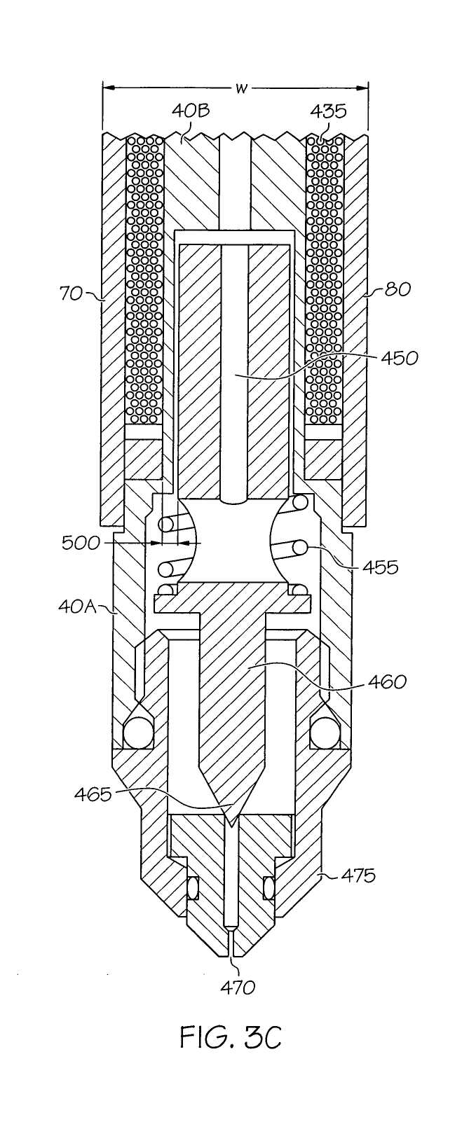

Referring next to FIGS. 2A and 2B and 3A, a fluid tube 40 and completed solenoid assembly made from such fluid tube 40 are shown. In the version shown in FIG. 2A, fluid tube 40 is of two-part construction, where the top 40B is made from a magnetic material, and may also function as a stop for the plunger (discussed below). The bottom 40A is made from a generally non-magnetizable material (for example, 304 stainless steel), and can be joined to the top 40B by friction welding, gluing, a threaded connection or other known methods. In one embodiment, male threads (not shown) in stop 40B engage with complementary female threads in bottom 40A at an axially inward potion of bottom 40A to form an integral fluid tube 40 structure. A centrally-disposed bore in fluid tube 40 forms a fluid chamber 401 that has at opposing ends a fluid inlet 402 and a fluid outlet 403. Threads 420 are formed in the fluid inlet and outlet 402, 403 to facilitate connection to stop 40B which in turn allows placement of a fluid conduit 90 (at the fluid inlet 402) and dispensing nozzle 475 (at the fluid outlet 403). The narrowed portion of bottom 40A can accommodate wound coil 435 (described below) such that not only is the coil closer to the moveable plunger 460 (shown in FIG. 3B) for enhanced actuation with lower current levels, it reduces the overall radial (i.e. widthwise) dimension of the assembled valve. Coil 435 is hidden in FIG. 2B by a sheath (for example, in the form of tape 440 or other suitable adhesive to keep the coil 435 in place during winding); it will be understood by those skilled in the art that in another embodiment, the coil 435 may be exposed. The top 40B of fluid tube 40 may be threadably engaged with a fitting 45 or related connector that accommodates at its other end a connection to fluid conduit 90.

Referring next to FIG. 3C, an enlarged cutaway view of the outlet of solenoid-operated fluid valve assembly 10 is shown. In this figure, details of a lower portion of the valve are shown. Plunger 460 moves reciprocally up and down within the bottom 40A of fluid tube 40 that is situated within outer casing 70 and cover 80 to define a width W. In a preferred (although not necessary) embodiment, W is no more than approximately fifteen millimeters wide. By winding the coil 435 directly onto the fluid tube 40, the inner diameter of the coil 435 allows an increase in the number of amp-turns available, as the direct contact removes the need for a separate bobbin. As previously stated, the bobbin thickness and the natural air gap or clearance between the bobbin and fluid tube of a conventional solenoid create inefficiency in coupling magnetic force to the plunger or armature. The gap in such conventional solenoids is made up of the bobbin material thickness plus the clearance between the bobbin and the outer diameter of the fluid tube, as well as the thickness of the fluid tube plus the air gap between the plunger and the inner diameter of the fluid tube. By contrast, FIG. 3C shows that the increased number of amp-turns of coil 435 allows the overall coil power to size ratio to increase. A reduced gap 500 is now defined as the space between just the wall of the plunger 460 and the inner diameter associated with coil 435. In this regard, the gap 500 is simply the space of non-magentic material that the flux must jump across in order to reach the plunger 460. The bigger the space, the weaker the conduction and the less efficient the valve is for a given amount of energy put in to it. In comparison, the total gap of a traditional solenoid valve includes the thickness of the bobbin wall, the air gap between the bobbin and the fluid tube over which it is placed, the thickness of the fluid tube and the air gap between the plunger outer diameter and fluid tube inner diameter. In one embodiment of the present invention (specifically, the two-part construction of FIG. 2A), the total gap 500 has been reduced by winding the coil 435 directly onto the fluid tube 40. This reduces the total gap by the bobbin wall thickness and the air gap between the bobbin inner diameter and fluid tube outer diameter. However, another embodiment of the current invention makes the fluid tube 40 out of three sections (not shown). In such a three-part construction, the portion of the fluid tube 40 made from non-magnetic material is reduced to a thin section near the middle of the thin part of fluid tube 40 that is used to wrap coil 435 around. In one form, the axial (i.e., lengthwise) portion of non-magnetic material is approximately one quarter of an inch. As a result of the three-part construction, the wall for the fluid tube 40 near the plunger 460 becomes magnetic, allowing flux to be efficiently conducted. Then, the total gap that the flux must bridge in order to conduct to the plunger 460 is reduced to only the air gap between the inner diameter of the fluid tube 40 and the outer diameter of the plunger 460. For simplicity of appearance, the version shown in the figure shows a continuous couple between the top 40B and bottom 40A of fluid tube 40, although as was previously mentioned, the connection between the top 40B and bottom 40A could be through complementary threads, friction welding or other suitable means. Such could be effected with either the two-part or three-part constructions discussed above.

By having the reduced air gap 500 between coil 435 and the plunger 460, there is an increase in attractive force among them. The material for the static stop of top 40B and plunger 460 can be solenoid quality stainless steel. In addition, there is a reduced air gap between the magnetic flux carrying coil frame 20 and stop 40B and plunger 460. There is an increase in attractive force between the static stop 40B and dynamic plunger 460 with reduced air-gaps between the flux carrying coil frame and poles. Referring with particularity to FIG. 2B, once the coil 435 is wound, the conductive ends 445 are situated so that they can engage leads from cable 30. To hold the portion of the coil adjacent the ends 445 in place, tape or other adhesive may be applied, as shown. Moreover, by winding the coil 435 directly to the fluid tube 40 and not to a separate bobbin, an increased number of wire turns may be achieved. By winding coil 435 directly to the fluid tube 400, a maximum outer diameter for the coil winding is achieved in order to stay with-in the narrow profile of a 15 millimeters or less valve width, while a greater presence of coil 435 adjacent the plunger 460 is available.

Furthermore, the coil 435 is wound so that the stop 40B and plunger 460 are positioned directly in the center area of the coil winding with a 0.015 inch air-gap or valve stroke distance. The pole pieces are attracted by a magnetic force when current is applied to the coil 435. By winding the coil 435 in precisely the same location from valve to valve, magnetic attracted forces remain consistent, promoting reproducibility. In addition, direct winding of the coil 435 onto the fluid tube 40 without an intervening bobbin allows for an optimum larger diameter and cross sectional area of the stop 40B and plunger 460. Since the cross sectional area of the plunger 460 is increased and the air gap reduced, there is an increase in magnetic attractive forces.

Areas of concern with increasing magnetic attractive force between the stop 40B and plunger 460 were addressed as indicated above by the capabilities of winding a coil 435 directly to the fluid tube 400 instead of to a separate bobbin. The reduction of air gaps between the magnetic flux carrying circuit, along with increasing the diameter and cross sectional area of the stop 40B and plunger 460, increased the magnetic attractive force between them. In testing, this was indicated by the amount and duration of initial peak or activation current that is required to attract the dynamic pole to the static pole by overcoming high fluid pressure and the return spring pre-loaded force. In one study, the initial peak or activation current was halved, going from approximately 2.8 amps to 1.4 amps. This means that lower current was able to overcome a higher force, exhibiting an increase in magnetic attractive force between the static stop 40B and dynamic plunger 460.

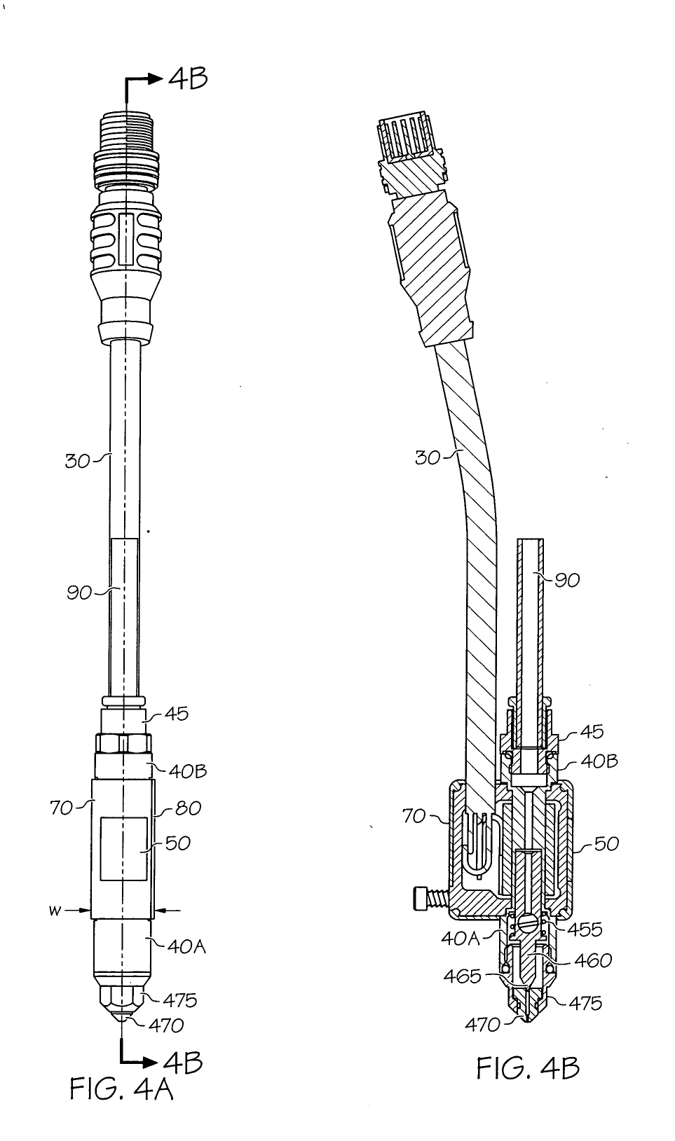

Referring with particularity to FIG. 4A, in a preferred embodiment, the width W of the assembly 10 is approximately fifteen (15) millimeters. Encompassed within the range of approximate widths are those due to manufacturing tolerances. For example, it is foreseeable that a tolerance of one percent or more may be present, resulting in widths between 14.85 and 15.15 millimeters. Thus, within this 15 millimeter wide outer dimension of outer casing 70 with cover 80, the assembly 10 contains a fluid tube 40, wire coil 435, coil frame 20 (which establishes the necessary magnetic flux path), threaded mounting holes to accept the fluid conduit 90, the electric cable 30, and purge switch 50. As mentioned above, outer casing 70 with cover 80 are optional; thus, in the event frame 20 defines the primary structure for the valve, the outer width W dimension is still preferably approximately fifteen millimeters. Electrical connections for the coil 435 and purge switch 50 are connected to cable 30 with proper grounding to coil frame. Connections are made to prevent shorting across the coil 435. As mentioned before, an encapsulating epoxy material can be used to fill the remaining interior portion of the outer casing 70 and frame 20. Cover 80 (which can be, for example, an injection molded nylon) is snapped on to the outer casing 70 to seal all internal connections. The box is then filled with the epoxy encapsulant which include in suspension a mixture of crystalline silica and calcium carbonate. This encapsulating material along with silicone around the switch 50 and cover is used to seal all connections made and to protect the coil 435 from harsh environments. The outer casing 70 houses the coil wrapped fluid tube 40, coil frame 20, switch 50, and electrical connections made to the cable 30.

The purge switch 50 is constructed to have a thin, tapered leads that can pass around the side of coil 435 on their way to attaching conductors from the cable 30. When pressed, the switch 50 acts as a local (i.e., at the site of the valve) purge test by closing a contact and telling the control to activate the valve. This allows an operator to purge the valve at the dispensing spot of the machine to which it is attached (for example, a gluing station) rather than at the control. The switch 50 was designed to have a width and a length to fit into the 15 mm wide valve construction.

The integrated valve assembly 10 was designed to have optimum performance of applying various individual glue patterns of dots, dashed lines, or a continuous glue beads. The narrow profile (preferably no more than approximately 15 millimeters wide) allows for the valves to be mounted next to each other and stacked having a center to center dimension of the same width between adjacent patterns. The individual valves 40, when stacked next to each other, are designed to apply cross web individual patterns to products such as windows in envelopes, bags, cartons, and any other similar application. The valve can also be installed in narrow locations in production machines where space is at a premium due to other components in the machine.

As mentioned above, the fluid tube 40 can be made from either a two-piece or three-piece construction. In the case of a two-piece construction, the fluid tube 40 and stop 45 make up the main structure of the valve. The fluid tube 40 is machined from non-magnetic stainless steel (for example, a 300-sreies stainless steel), while the stop 45 is machined from a solenoid quality stainless steel that exhibits magnetic qualities when a magnetic field is generated by a coil 435. The fluid tube 40 is machined to set tolerances to keep air-gaps at a minimum inside the magnetic flux carrying circuit. At one end is the stop 45 is located in the center of a wound coil 435. It has a machined fluid inlet 402 through the center that delivers fluid into the fluid chamber 410, through and around the plunger 460, and out the fluid outlet 403. The fluid tube 40 has a machined spring seat to locate the return spring 455 around plunger 460 and has a machined thread to adapt nozzle inserts 470 and nozzle body assemblies 475 of varying orifice diameters and configuration.

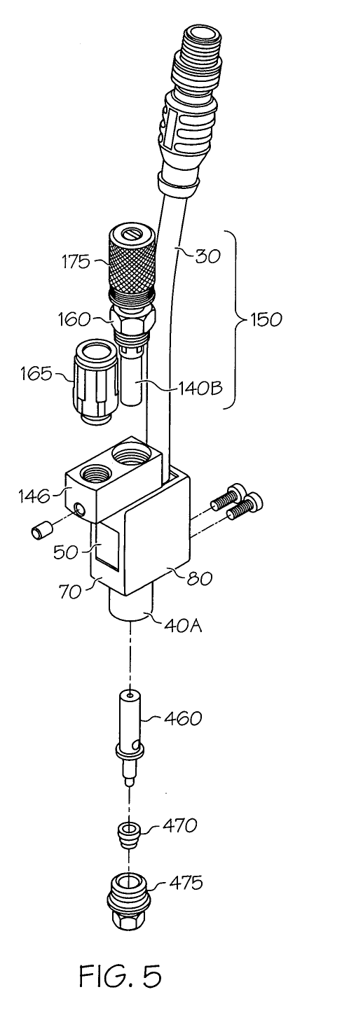

Referring next to FIGS. 5 through 7, details of the solenoid-operated fluid valve assembly 10 with an alternate embodiment for a stop 140B is shown. Stop 140B is part of stop subassembly 150, and unlike the stop 40B shown and discussed earlier, is capable of local adjustment of its stroke position, such as through a ratchet mechanism or the like. In applications where the valve assembly 10 is being used for gluing or related adhesive applications (such as on a folder gluer machine), adjustment of the stroke allows fine-tuning of certain adhesive deposition patterns. For example, in situations requiring short dot glue patterns at higher machine speeds, such adjustment allows better tailoring of the stroke to meet the pattern needs. An additional feature of the fluid tube 40 in the present configuration is that it can be of one-piece construction, as the stop 140B now need not be formed as part of the fluid tube 40. In such case, the stop subassembly 150 is removable.

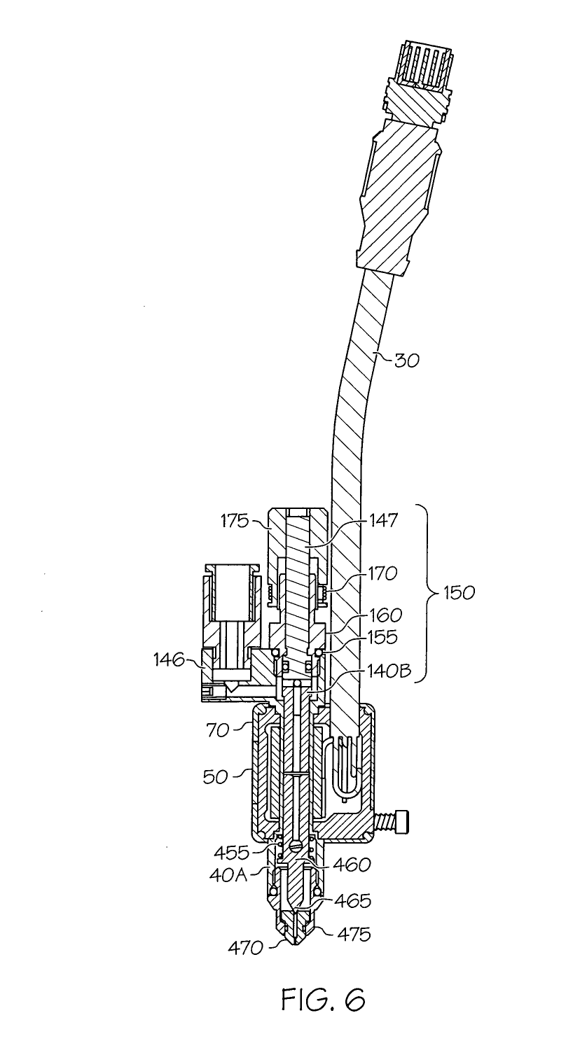

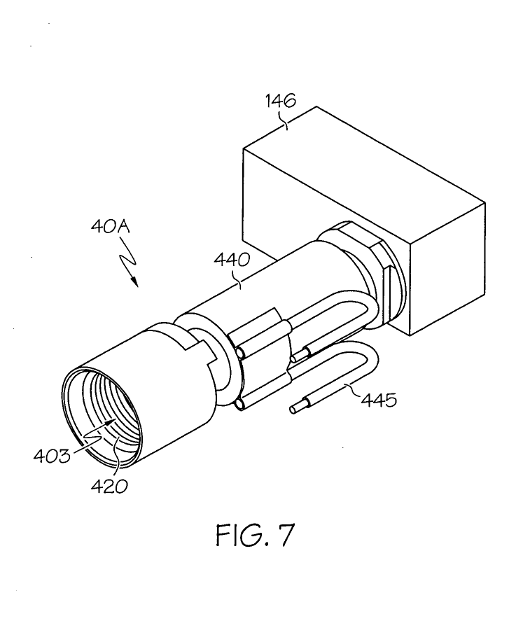

Referring first to FIGS. 5 and 6, stop 140B of stop subassembly 150 fits through a threaded opening of stop frame 146 that mounts to the top (inlet) side of outer housing 70 to maintain the substantially linear flowpath for the liquid that flows through fluid conduit 90. Stop frame 146 also includes another threaded opening that is offset relative to the fluid conduit 90. The fluid conduit 90 can be coupled through a fitting 165, threaded at one end BSPP with a O-ring and push-lock at the other end to receive a plastic hose such as fluid conduit 90. It could also be threaded at the other end to receive a threaded hose. In one form the conduit can be an eight millimeter (8 mm) plastic tube. Adjustment of the stop 140B is effected through turning of knurled knob 175. The adjustable stop 140B increases the stroke from 0 to 0.29″ to make the valve dispense more volume. The lower end of stop 140B is axially aligned with and abuts plunger 460 within in fluid tube 40, while movement of stop 140B is fixed at its upper end through connection to knurled knob 175 through a threaded screw 147. An adapter nut 160 engages the threaded opening of stop frame 146, which by virtue of its fixed attachment to fluid tube 40 ensures that stop 145 is stationary relative to the valve assembly 10. O-rings 155 are used to prevent or lessen the likelihood of fluid leakage around threads and locations where separate components are joined together. In the present form, stop 140B is made from a magnetic material. In the embodiment shown, one full revolution of knurled knob 175 moves the stroke of stop 140B by twenty nine thousandths (0.029 inches). A one-half turn sets the stroke at approximately fourteen thousandths, which is the standard setting of the stroke of the stop 40B of the previous embodiment. It will be appreciated by those skilled in the art that industry-standard stops could be used for stop 40B. Referring with particularity to FIG. 7, a detail view showing connection of a coil-wound fluid tube 40 to stop frame 146 indicates preservation of an optional substantially linear flowpath for the fluid.

While certain representative embodiments and details have been shown for purposes of illustrating the invention, it will be apparent to those skilled in the art that various changes may be made without departing from the scope of the invention, which is defined in the appended claims.

What is claimed is:

1. A solenoid-operated valve comprising:
a valve body comprising:
a fluid tube defining a fluid chamber with fluid inlet and fluid outlet formed therein;
an electrically-conductive coil wrapped directly around at least a portion of said fluid tube such that upon a current flow through said coil, said coil forms a magnetic field; and
a frame defining a flux path for said magnetic field;
a plunger disposed within said fluid chamber and moveably responsive to said magnetic field; and
a bias force cooperative with said plunger to selectively keep said fluid outlet closed, said bias force configured to be overcome by operation of said magnetic field on said plunger such that said fluid outlet opens, thereby allowing fluid flow through said fluid chamber.

2. The valve of claim 1, further comprising an integrated switch configured to provide local purging or testing of said valve.

3. The valve of claim 1, further comprising a stop configured to limit travel of said plunger.

4. The valve of claim 3, wherein said fluid tube and said stop are threadably engaged to form an integral structure.

5. The valve of claim 4, wherein said stop comprises a magnetizable material and said fluid tube comprises a substantially non-magnetizable material.

6. The valve of claim 3, wherein said fluid tube defines a smaller radial profile than said stop.

7. The valve of claim 1, wherein said bias force comprises a spring.

8. The valve of claim 1, wherein said fluid chamber is fluidly isolated from said coil.

9. The valve of claim 1, wherein a widthwise dimension of said valve is approximately 15 millimeters.

10. The valve of claim 1, wherein said stop is adjustable to allow changes in plunger travel distance.

11. The valve of claim 1, further comprising an outer casing formed around said valve body.

12. The valve of claim 11, wherein a widthwise dimension of said outer casing is approximately fifteen millimeters.

13. The valve of claim 11, further comprising a filler material placed between said outer casing and said valve body.

14. The valve of claim 1, wherein said fluid chamber extends from said fluid inlet to said fluid outlet along a substantially linear path therebetween.

15. An adhesive dispenser comprising:
a plurality of solenoid-operated valves configured to be placed in a side-by-side arrangement, each of said valves comprising:
a valve body comprising:
a fluid tube defining a fluid chamber with fluid inlet and fluid outlet formed therein;
an electrically-conductive coil wrapped directly around at least a portion of said fluid tube such that upon a current flow through said coil, said coil forms a magnetic field; and
a frame defining a flux path for said magnetic field;
a plunger disposed within said fluid chamber and moveably responsive to said magnetic field; and
a bias force cooperative with said plunger to selectively keep said fluid outlet closed, said bias force configured to be overcome by operation of said magnetic field on said plunger such that said fluid outlet opens, thereby allowing fluid flow through said fluid chamber;
an electric cable configured to provide current to said electrically-conductive coil;
a fluid conduit fluidly coupled to said fluid inlet of said fluid tube; and
an outlet nozzle coupled to said fluid outlet of said fluid tube.

16. A method of dispensing a fluid through a valve, said method comprising:
configuring a fluid tube to comprise a fluid inlet and a fluid outlet, an outer surface and an inner surface the latter of which defines a fluid chamber therebetween;
arranging a coil winding directly around at least a portion of the periphery of said outer surface between said fluid inlet and outlet;
moveably disposing a plunger within said fluid chamber such that it is biased in a closed position;
fluidly connecting a fluid supply to said fluid inlet end; and
passing electric current through said coil winding such that said plunger overcomes said bias to move to an open position, thereby allowing fluid from said fluid supply to pass through said fluid outlet.

17. The method of claim 16, further comprising placing said fluid tube within a frame that defines a flux path such that upon formation of said magnetic flux, said magnetic flux is enhanced in said fluid tube by its proximity to said frame.

18. The method of claim 16, wherein said valve defines a widthwise dimension that is no greater than fifteen millimeters wide.

19. The method of claim 16, further comprising placing a stop adjacent one of said fluid inlet and outlet to limit travel of said plunger in said fluid chamber.

20. The method of claim 19, further comprising adjusting a stroke between said plunger and said stop.

21. The method of claim 16, further comprising fluidly isolating said coil winding from said fluid.

22. The method of claim 16, further comprising pressing a switch disposed on said valve such that said valve is purged of fluid therein.
